(19) United States
(12) Patent Application Publication
(10) Pub. No.: US 2009/0189445 A1
(43) Pub. Date: Jul. 30, 2009

(54) RENEWABLE ENERGY MANAGEMENT AND STORAGE SYSTEM

(75) Inventor: Michael Strizki, Hopewell, NJ (US)

Correspondence Address: BROWN & MICHAELS, PC;400 M & T BANK BUILDING, 118 NORTH TIOGA ST, ITHACA, NY, 14850, US

(73) Assignee: Renewable Energy Holdings, LLC, Hopewell, NJ (US)

(21) Appl. No.: 12/357,649

(22) Filed: Jan. 22, 2009

Related U.S. Application Data
(60) Provisional application No. 61/023,256, filed on Jan. 24, 2008.

(51) Int. Cl. H02J 5/00

(52) U.S. Cl. 307/21

(57) ABSTRACT

An integrated system of renewable energy management and storage that receives direct current generated from renewable sources and intelligently routes the electrical power between a direct current circuit and an alternating current circuit, and at the same time determines the optimal routing for electrical storage based on usage and demand. Electrical power from the direct current circuit can be converted to alternating current electrical power and supplied to the alternating current circuit, or vice versa. Electrical power from either the direct current circuit or the alternating current can be stored in the energy storage subsystem. Electric energy can be further converted to and stored as gaseous hydrogen and can supply for other applications that consume gaseous hydrogen. The system can work with a connection to a utility grid or as a stand-alone system.

### REFERENCE TO RELATED APPLICATIONS

This application claims one or more inventions which were disclosed in Provisional Application No. 61/023256, filed Jan. 24, 2008, and entitled “RENEWABLE ENERGY MANAGEMENT AND STORAGE SYSTEM”. The benefit under 35 USC §119(e) of the United States provisional application is hereby claimed, and the aforementioned application is hereby incorporated herein by reference.

### BACKGROUND OF THE INVENTION

1. Field of the Invention

This invention relates generally to electric energy generation and storage, and the management thereof. Specifically, the present invention relates to an integrated system that converts, stores, and manages energy harvested from renewable sources to provide uninterrupted electrical output, and gaseous hydrogen output.

2. Description of Related Art

Renewable energy sources are attracting more attention as the global climate change resulting from human activity becomes apparent. Renewable energy sources such as solar, wind, and small hydroelectric generators, are clean sources of energy that are abundant in many geographic locations, and do not produce any greenhouse gas emissions. However, several existing technical problems hinder the widespread adoption of these energy sources as stand-alone implementations, as well as their integration into the existing power infrastructure. Because of the nature of these renewable energy sources, the power supplied tends to be intermittent and unreliable (“intermittency problem”). For example, solar energy output is dictated by the day/night cycle, and is affected by weather conditions. Wind energy is also affected by short term and seasonal weather patterns. To maintain availability, current renewable energy implementations usually involve electrochemical cells (e.g., lead acid batteries) for temporary energy storage. The current electrical energy storage means of overcoming this intermittency problem are bulky, inefficient, expensive, and harmful to the environment.

A regenerative fuel cell system can also serve as an alternative energy storage system. The regenerative fuel cell takes the direct current (DC) output of an energy source and directs it to an electrolyzer, where the electric energy is used to electrolyze water and splits the water molecule into gaseous hydrogen and oxygen. The hydrogen and oxygen gas can be stored in tanks. Hydrogen gas is stable over a long period of time. Unlike traditional electrochemical cells, the electric energy stored in the form of hydrogen gas does not diminish overtime. When stored energy is required, the hydrogen gas is then recombined in a fuel cell with oxygen either from the air or from an oxygen storage tank. The fuel cell converts the stored chemical energy back to electricity.

The power output from renewable sources such as solar and wind generators are usually DC. The energy storage solutions, such as battery banks and regenerative fuel cell systems, also use DC input and output (e.g., the electrolyzer requires DC input, and the fuel cell generates DC output). However, for household or business consumption, the power supply would often need to be alternating current (AC). Thus, the electrical power output from the renewable energy sources and the storage solution often times must be converted to AC output. To convert the direct current of renewable energy sources to AC, a DC to AC inverter is usually needed. A conventional regenerative fuel cell system usually includes multiple inverters, power supplies, and regulators for each of the different components, e.g., the electrolyzer and fuel cell require separate power supplies and inverters, which usually leads to an unnecessarily complex system, and drives up the capital requirement, and installation and maintenance cost of the system.

Some states now require that utility companies buy back the extra capacity that customers generate from renewable sources. However, integration of the renewable energy system with the existing public utility grid is still cumbersome and expensive, which also hinders the adoption of renewable energy.

It is therefore desirable to have a system that intelligently manages the components of a renewable energy generation and storage system. It is also desirable to employ integrated electronics for the control and conversion of power input and output to the various components of the system. It is further desirable to have unitarily-integrated renewable energy management and control system for easy deployment and maintenance. Moreover, it is desirable to integrate the renewable energy system with existing grid power generation and transmission infrastructure, enabling the energy needs of a household or business to be intelligently managed so that energy production, storage, and transmission back through the utility grid can occur at the most advantageous times for all parties concerned with minimal user input.

### SUMMARY OF THE INVENTION

The present invention teaches a renewable energy management and storage system, which comprises a Multifunctional Power Conditioner, an energy storage subsystem, and a Smart Controller. The Multifunctional Power Conditioner is electrically connected to a direct current electrical power circuit and an alternating current electrical power circuit. The direct current electrical power circuit is electrically connected to at least one renewable energy source. The Multifunctional Power Conditioner is electrically connected to the energy storage subsystem and the Smart Controller. The energy storage subsystem is also electrically connected to the Smart Controller.

The Smart Controller intelligently directs or commands the Multifunctional Power Conditioner to route electrical power between the direct current circuit and the alternating current circuit and at the same time determines the optimal routing for electrical storage based on usage and demand. Electrical power from the direct current circuit can be converted to alternating current electric power via the Multifunctional Power Conditioner, and is supplied to the alternating current circuit.

Electrical power from either the direct current circuit or the alternating current can be stored in the energy storage subsystem. The energy storage subsystem can be one or more electrochemical cells or ultracapacitors. The energy storage subsystem can also be a regenerative fuel cell system that comprises at least one electrolyzer, at least one fuel cell, and at least one hydrogen storage tank.

The electrolyzer and the fuel cell are electrically connected to the Multifunctional Power Conditioner and the Smart Controller, and also provide gas-tight connections with the hydrogen storage tank. Electrical power from the direct current circuit is conditioned via the Multifunctional Power Conditioner and supplied to the electrolyzer.

Direct current electric power generated from the fuel cell can be directed to battery or ultracapacitor storage, or may also be converted to alternating current electric power via the Multifunctional Power Conditioner and supplied to the alternating current circuit. The hydrogen storage tank also provides a port for gaseous hydrogen output.

The Smart Controller of the present invention renewable energy management and storage system comprises a sensor input module that receives sensor inputs from components of the system, a processor which processes the sensor inputs, and a controller that sends control signals to the components of the system.

The Multifunctional Power Conditioner of the renewable energy management and storage system of the present invention comprises a direct current input converter, a direct current buck/boost, a direct current to alternating current inverter, and a direct current bus. The direct current input converter, the direct current buck/boost, and the direct current to alternating current inverter are in electrical communication with the direct current bus.

The system of the present invention can also connect to an alternating current public utility grid. Electric power from the public utility grid can be stored in the energy storage subsystem. Energy stored in the energy storage subsystem can be extracted and converted to alternating current electric energy to be supplied to the alternating current circuit. Electric power from the direct current circuit can be converted to alternating current via the Multifunctional Power Conditioner and supplied to the public utility grid.

Major components of the present invention are housed in a unitary enclosure. Components of the energy storage subsystem, such as the battery/ultracapacitor bank, and hydrogen storage tank, can be housed in one or more separate enclosures that easily connect to the rest of the system.

### BRIEF DESCRIPTION OF THE DRAWING

FIG. 1 is a schematic block diagram showing major components of one embodiment of the renewable energy management and storage system of the present invention;

FIG. 2 is a schematic block diagram showing the input and output control logic for one embodiment of the Smart Controller and electrolyzer;

FIG. 3 is a schematic block diagram showing the input and output control logic for one embodiment of the Smart Controller and fuel cell;

FIG. 4 is a schematic block diagram showing the input and output control logic for one embodiment of the Smart Controller and Multifunctional Power Conditioner; and

FIG. 5 is a schematic circuit diagram for one embodiment of the Multifunctional Power Conditioner.

### DETAILED DESCRIPTION OF THE INVENTION

The present invention teaches an integrated system of renewable energy management and storage. The system supplies all energy needs without a carbon footprint. No fossil or limited fuel is used or required in the operation of the system. The system can be used in connection with a public utility grid or as a stand-alone system that does not connect to a utility grid. The use of the system of the present invention can significantly reduce or eliminate future energy costs and allow for the accurate estimate of future energy costs.

The present invention comprises of a Multifunctional Power Conditioner, a Smart Controller, and an energy storage subsystem. The system connects to any direct current (DC) producing renewable energy sources, such as solar, wind, hydroelectric, biomass, and geothermal generators, and supplies alternating current for home or business consumption.

The system provides a continuous power reserve during power generation interruption. If the system is connected to a public utility grid, the system can also serve as a backup generator, providing backup power when there is an interruption of the power supply from the public utility grid. The system can also route the power generated from the renewable source(s) back to the public utility grid in times of surplus, or based on a predetermined time schedule, (e.g., selling electricity generated at a higher peak hourly rate to the public utility grid during the peak hours, and using lower-priced, off-peak electricity from the grid to charge the energy storage subsystem). The system can also operate independently from the grid.

The system of the present invention efficiently manages and stores intermittent DC electricity from renewable sources, such as solar, wind, geothermal, biomass, hydroelectric, etc., in order to supply an uninterruptible supply of 115-230 Vac and 50/60 HzV of alternating current (AC) “Power Out” for electrical demand, and “Hydrogen Out” for heating, cooking, hydrogen-vehicle refueling, and other uses of gaseous hydrogen. Electrical energy from any renewable or traditional electrical source can be stored in the form of gaseous hydrogen to be used in a backup generator capacity (i.e., electricity can be generated from the stored gaseous hydrogen to supply power). Gaseous hydrogen is chemically stable. The system of the present invention can store electricity from any electrical energy sources indefinitely without breakdown over time. Reconversion from hydrogen to electricity produces no emissions. The only by-products are heat and pure water.

The system of the present invention can also be used in cooperation with local utilities to offset peak energy demands during peak energy conditions (grid-interactivity). The system may be configured to purchase electricity from the grid during off-peak hours at a low price, and to sell electricity generated from renewable sources, such as solar and wind, during the peak hours at a higher peak hourly rate back to the public utility grid.

Alternatively, the present invention is also capable of storing energy by charging a battery bank or ultracapacitors. The battery bank or ultracapacitors can also be used in conjunction with the hydrogen energy storage system. Charging of the battery bank/ultracapacitors or the hydrogen storage system can be scheduled to take advantage of the lower, off-peak rate.

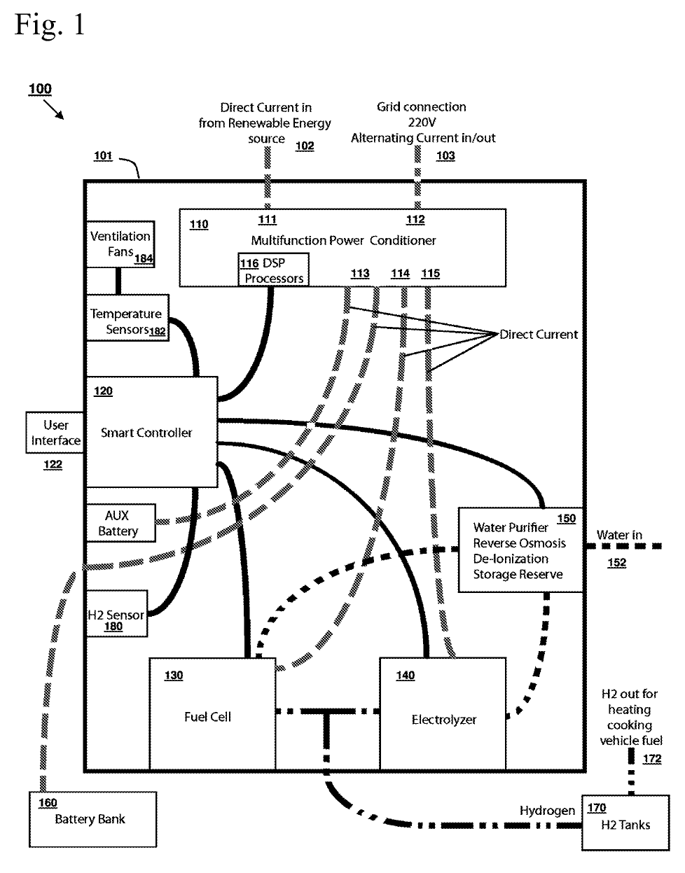

FIG. 1 shows a schematic block diagram showing major components of one embodiment of the present renewable energy management and storage system 100. The major components of the system 100 are integrated in a single cabinet 101 to facilitate deployment and maintenance.

Energy storage subsystems components, such as an electrochemical battery bank 160, an ultracapacitor bank (not shown), or hydrogen storage tanks 170, can be housed in one or more separate enclosures, readily connectible to the rest of the system 100.

DC electrical power generated from renewable energy sources is connected to a Multifunctional Power Conditioner 110 through its “Direct Current in” connector 102. The “Alternating Current in/out” connector 103 of the Multifunctional Power Conditioner 110 provides AC power to supply demand for the system and can also provide grid connection if the system is integrated to a public utility grid.

The Multifunctional Power Conditioner 110 comprises, among other components, a Digital Signal Processing (DSP) Processor 116. The DSP Processor 116 is connected to a Smart Controller 120. The Smart Controller 120 can be programmed to monitor and control its functions based on load and demand parameters and available energy resources. It also can be configured for either on-grid or off-grid use by executing commands in the controlling software.

The Multifunctional Power Conditioner 110 also provides direct current to the battery bank 160 or ultracapacitors for charging 113. At times when the battery bank or ultracapacitors are discharging, the Multifunctional Power Conditioner 110 receives the direct current 113 from the battery bank 160 or ultracapacitors to supply “AC Out” 103.

The Multifunctional Power Conditioner 110 further acts as the DC power supply 115 for an electrolyzer 140. The electrolyzer 140 is a third-party, commercially available unit that produces gaseous hydrogen by electrolyzing water. The electrolyzer 140 operates at relatively high pressure (about 400 psig-5600 psig). The gaseous hydrogen produced from the electrolyzer 140 is stored in a hydrogen gas storage tank 170.

The hydrogen gas storage tank 170 provides a “Hydrogen Out” port 172, through which stored gaseous hydrogen can be used for heating, cooking, or refueling hydrogen vehicles. The hydrogen gas storage tank 170 also feeds a fuel cell stack 130, where the hydrogen gas is recombined with oxygen in the ambient air to form water. In some embodiments of the invention, the fuel cell stack 130 is a commercially available proton exchange membrane (PEM) fuel cell stack. However, any fuel cell stack that generates electricity by combining gaseous hydrogen with oxygen can be used.

The energy that is produced by the reconversion of hydrogen is harvested by the fuel cell stack in the form of DC electricity. DC output 114 from the fuel cell stack 130 is directed to the Multifunctional Power Conditioner 110.

A Water Purifier and Storage Reserve 150 may be needed in some implementations of the present invention. The Water Purifier and Storage Reserve 150 is also a third-party commercially available unit that purifies water supplied from “Water in” 152 through reverse osmosis, de-ionization, or any other appropriate water purification process that essentially removes all impurities (i.e., solids and minerals) in the water supply. The Water Purifier and Storage Reserve 150 provides water supply to the electrolyzer 140, keeps the fuel cell stack 130 at a proper moisture level, and receives excess water produced in the fuel cell stack 130. The system may also comprise a variety of sensors, e.g., H₂ sensors 180 and temperature sensors 182, that monitor the status of all components and conditions within the main system cabinet.

### Smart Controller

The Smart Controller 120 is the brain of the system of the present invention. It is a custom-built computer running custom software which controls all functions of the system of the present invention.

One embodiment of the Smart Controller is a microprocessor-based single board computer running custom software with its User Interface 122 generated using Visual Basic®. It controls the routing of power via the Multifunctional Power Conditioner 110 for both input and output, while also determining the optimum routing for electrical storage based on usage and demand.

The Smart Controller 120 processes information from the Multifunctional Power Conditioner 110 (e.g., from the DSP processors 116) to determine the direction and level of power. The Smart Controller 120 also determines when and at what level to run the fuel cell stack 130 and the electrolyzer 140.

If a Water Purifier and Storage Reserve 150 is implemented, the Smart Controller 120 determines when to run the Water Purifier (e.g., reverse osmosis/de-ionization plant) based on water reserve levels and the needs of the electrolyzer.

The Smart Controller 120 monitors one or more H₂ sensors 180, temperature sensors 182, battery level, hydrogen fuel level, and the control ventilation fan 184 inside the cabinet. With such monitoring, the Smart Controller 120 will automatically shut down in any dangerous event, such as a hydrogen leak, or any failure of necessary components. It will perform the necessary processes to maintain a constant “power out” condition by bypassing any failed or malfunctioning component. The Smart Controller 120 is connected to a User Interface 122, and performs functions based on the User Interface's inputs.

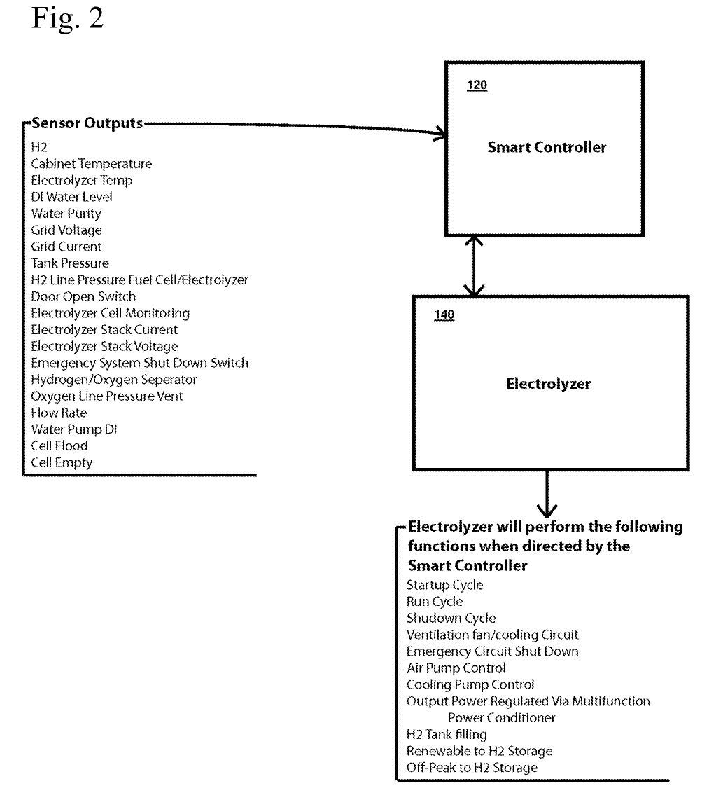

FIG. 2 shows a schematic block diagram showing the input and output control logic for one embodiment of Smart Controller 120 and an electrolyzer 140.

The Smart Controller 120 receives sensor outputs from the electrolyzer 140 and other components of the system, which includes, but are not limited to: H₂, Cabinet Temperature, Electrolyzer Temperature, De-Ionized (DI) Water Level, Water Purity, Grid Voltage, Grid Current, Tank Pressure, H₂ Line Pressure Fuel cell stack/Electrolyzer, Door Open Switch, Electrolyzer Cell Monitoring, Electrolyzer Stack Current, Electrolyzer Stack Voltage, Emergency System Shut Down Switch, Hydrogen/Oxygen Separator, Oxygen Line Pressure Vent, Flow Rate, DI Water Pump, Cell Flood, and Cell Empty. Based on the sensor outputs, the Smart Controller 120 would direct the electrolyzer 140 to perform a set of predetermined operations, which include, but are not limited to: Startup Cycle, Run Cycle, Shutdown Cycle, Ventilation Fan/Cooling Circuit, Emergency Circuit Shut Down, Air Pump Control, Cooling Pump Control, Output Power Regulated via Multifunctional Power Conditioner, H₂ Tank Filling, Renewable to H₂ Storage, and Off-Peak to H₂ Storage.

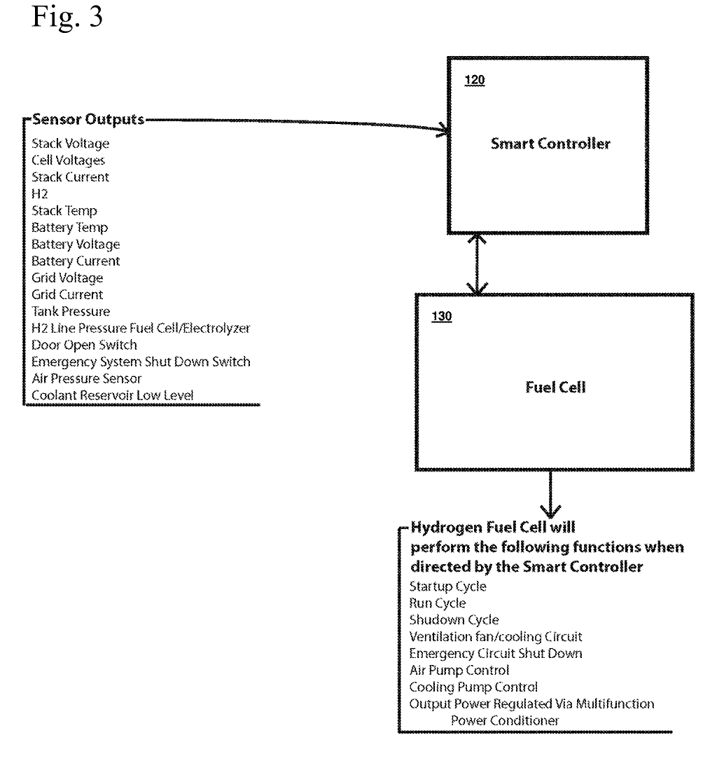

FIG. 3 shows a schematic block diagram showing the input and output control logic for one embodiment of Smart Controller 120 and a hydrogen fuel cell stack 130. The Smart Controller 120 receives sensor outputs from the hydrogen fuel cell stack 130 and other components of the system, which include but are not limited to: Stack Voltage, Cell Voltages, Stack Current, H₂, Stack Temperature, Battery Temperature, Battery Voltage, Battery Current, Grid Voltage, Grid Current, H₂ Tank Pressure, H₂ Line Pressure Fuel Cell/Electrolyzer, Door Open Switch, Emergency System Shut Down Switch, Air Pressure Sensor, and Coolant Reservoir Low Level. Based on the sensor outputs, the Smart Controller 120 would direct the hydrogen fuel cell stack 130 to perform a set of predetermined operations, which include, but not are limited to: Startup Cycle, Run Cycle, Shutdown Cycle, Ventilation Fan/Cooling Circuit, Emergency Circuit Shut Down, Air Pump Control, Cooling Pump Control, and Output Power Regulated via Multifunctional Power Conditioner.

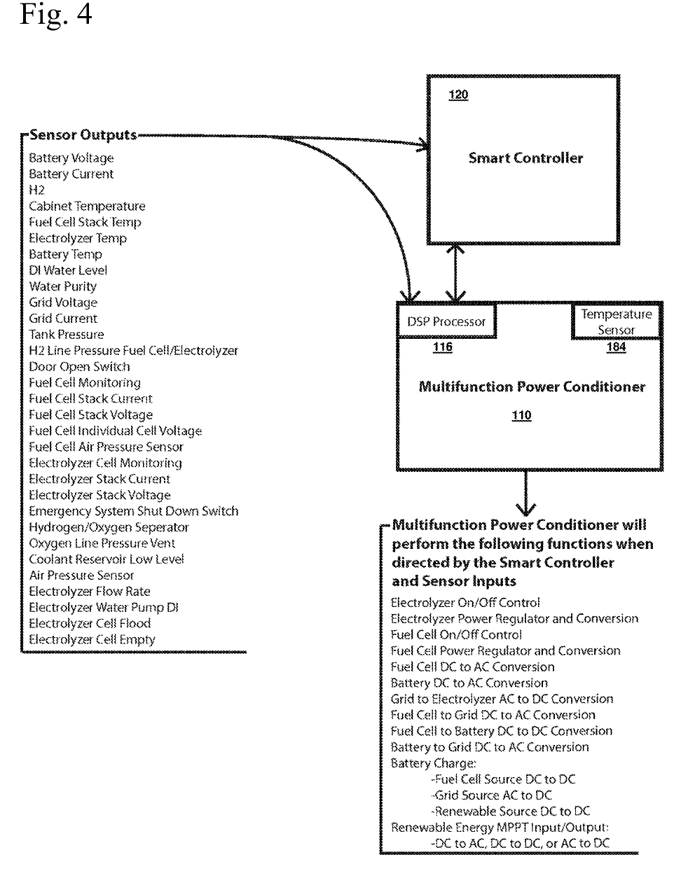

FIG. 4 shows a schematic block diagram showing the input and output control logic for one embodiment of Smart Controller 120 and Multifunctional Power Conditioner 110. The Smart Controller 120 receives sensor outputs from the Multifunctional Power Conditioner 110 and other components of the system, which include, but are not limited to: Battery Voltage, Battery Current, H₂, Cabinet Temperature, Fuel Cell Stack Temperature, Electrolyzer Temperature, Battery Temperature, DI Water Level, Water Purity, Grid Voltage, Grid Current, Tank Pressure, H₂ Line Pressure Fuel Cell/Electrolyzer, Door Open Switch, Fuel Cell Monitoring, Fuel Cell Stack Current, Fuel Cell Stack Voltage, Fuel Cell Individual Cell Voltage, Fuel Cell Air Pressure Sensor, Electrolyzer Cell Monitoring, Electrolyzer Stack Current, Electrolyzer Stack Voltage, Emergency System Shut Down Switch, Hydrogen/Oxygen Separator, Oxygen Line Pressure Vent, Coolant Reservoir Low Level, Air Pressure Sensor, Electrolyzer Flow Rate, Electrolyzer Water Pump DI, Electrolyzer Cell Flood, and Electrolyzer Cell Empty. The Smart Controller 120 also communicates with the DSP Processor 416 of the Multifunctional Conditioner 110.

Based on the sensor outputs, the Smart Controller 120 would direct the Multifunctional Power Conditioner 110 to perform a set of predetermined operations, which include, but are not limited to: Electrolyzer On/Off Control, Electrolyzer Power Regulator and Conversion, Fuel Cell On/Off Control, Fuel Cell Power Regulator and Conversion, Fuel Cell DC to AC Conversion, Battery DC to AC Conversion, Grid to Electrolyzer AC to DC Conversion, Fuel Cell to Grid DC to AC Conversion, Fuel Cell to Battery DC to DC Conversion, Battery to Grid DC to AC Conversion, Battery Charge (i.e., Fuel Cell Source DC to DC, Grid Source AC to DC, and Renewable Source DC to DC), and Renewable Energy maximum power point tracking (MPPT) Input/Output (i.e., DC to AC, DC to DC, or AC to DC).

The Smart Controller 120 has one or more User Interfaces 122, which include, but are not limited to: a display, such as an LCD screen, with User Interface control means or other user input devices, such as buttons, a keyboard, a pointing device or a touch screen, that allow user programming, troubleshooting, and display of operational status, as well as an “Ethernet out” connector to transmit performance data via the World Wide Web for remote customer viewing, monitoring system status, and/or diagnosing any system errors.

The Smart Controller 120 can also be programmed to control the system to perform in optional modes:

First, it allows one to route power during peak load times to the grid as opposed to routing electricity to storage, which allows a user to sell power back to the utility company at peak hours for a premium rate.

Second, it allows for one to run the system solely as a backup power source. The system will take energy as needed to maintain storage in hydrogen and will use that stored energy by converting hydrogen to electricity via the fuel cell stacks during a power outage.

Third, it allows for one to run the system as a hydrogen refueling station and heating/cooking fuel generator. It can take available energy and convert it to hydrogen gas to be subsequently used for refueling a hydrogen vehicle, or for use when excess heat is needed in manufacturing or any other application. Any situation that demands hydrogen gas and/or stored energy can be addressed with this system.

### Multifunctional Power Conditioner

One aspect of the Multifunctional Power Conditioner 110 is to eliminate power inefficiencies caused by having multiple inverters in an integrated system. Currently, renewable energy systems use multiple inverters, power supplies, and regulators for different applications, such as solar inverters, battery backup inverters, fuel cell inverters, and electrolyzer inverters. Each type of inverter adds a level of inefficiency through additional costs associated with installation labor, space for housing separate enclosures, separate inspections, separate wiring, and reliability issues.

A Multifunctional Power Conditioner 110 greatly simplifies the inverter function and provides regulated DC power to the electrolyzer and fuel cell stack, providing battery charging and converting DC to AC electricity at high efficiency.

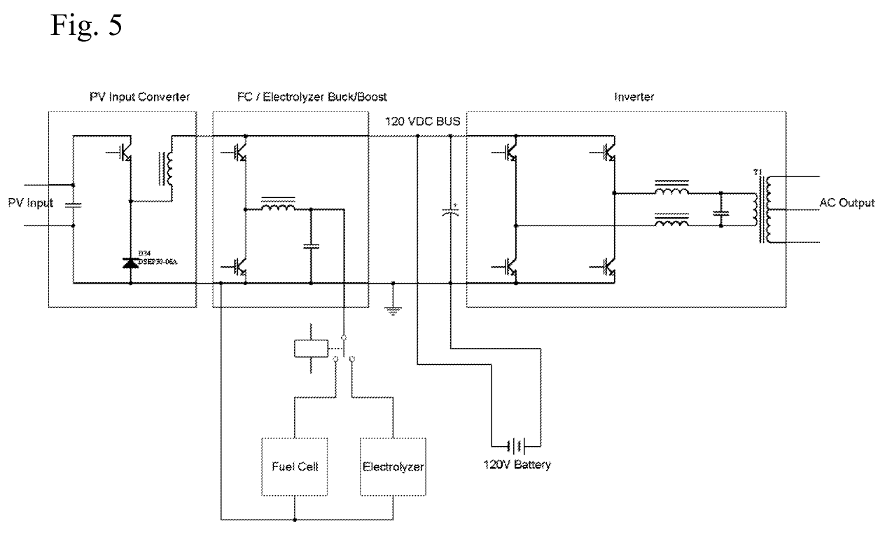

FIG. 5 shows a schematic circuit diagram for one embodiment of the Multifunctional Power Conditioner 110. The Multifunctional Power Conditioner 110 comprises of a number of power blocks, and is software configurable by commands from the Smart Controller. Three power blocks are shown in this embodiment: a PV Input Converter, a Fuel Cell/Electrolyzer Buck/Boost Converter, and a DC to AC Inverter.

The PV Input Converter is a Direct Current Input Converter. It processes the renewable energy DC input and provides DC power to charge the battery/ultracapacitor bank, and to power the electrolyzer and the DC to AC Inverter. The power conversion includes a Maximum Power Point Tracker (MPPT) set for the specific alternative power source (e.g., solar or wind energy) to supply the balance of components in the system.

The Fuel Cell/Electrolyzer Buck/Boost Converter is a software reconfigurable power stage, based on one set of power components, that can deliver a regulated current, determined by the Smart Controller 120, to the electrolyzer 140 as a buck converter, or a regulated DC voltage derived from the fuel cell stack 130 to the inverter or battery/ultracapacitor 160. These functions are determined by the Smart Controller 120 according to the power flow requirements.

The DC to AC Inverter is bidirectional and is also configurable by software. It provides power to the public utility grid in one configuration, stand-alone power in another, and charges the battery/ultracapacitor or supplies the electrolyzer in yet another power flow configuration.

The power electronic subassemblies of the Multifunctional Power Conditioner 110 comprise a DSP processor 116, which senses and controls each of the subassemblies based on commands from the Smart Controller 120. It also comprises an unregulated renewable energy source/DC input, e.g. the Direct Current Input Converter. These DC energy sources have a wide range of input voltages (up to 600 Vdc). This DC energy is regulated and routed based on commands from the DSP processor.

The power electronic subassemblies of the Multifunctional Power Conditioner 110 may also comprise a battery/ultracapacitor bank 160 or AUX battery charger. This charger regulates power to the energy storage unit based on the state of charge. Programmable charging profiles can be input into the Smart Controller using the attached User Interface or the remote control interface through the “Ethernet out” connector. Batteries 160 or ultracapacitors provide immediate response to load power demands. Electricity can also be extracted and routed from the batteries based on commands from the DSP processor 116.

The power electronic subassemblies of the Multifunctional Power Conditioner 110 further comprise a multifunction DC/DC power regulation module. The multifunctional converter provides the electrolyzer 140 with regulated DC input from the DC input and/or DC/AC inverter (running in the direction of converting AC to DC). The multifunctional converter can also integrate a fuel cell power regulation module, e.g., the Fuel Cell/Electrolyzer Buck/Boost Converter. The fuel cell power regulation module receives DC energy from the fuel cell stack and routes the power based on commands from the DSP processor.

The power electronic subassemblies of the Multifunctional Power Conditioner 110 further comprise a DC/AC inverter with isolated output. The inverter can be programmable for 50/60 Hz and a variety of output voltages, e.g., 110/120V, 220/240V. It can output AC power to the grid, as well as take in AC power from the grid. The inverter can provide either stand-alone power for applications where there is no grid present, or can feed excess power to the grid when available (or upon external command in peak-shaving applications). It senses voltage from the grid, and if none exists, it will isolate the unit from the grid via a double pole contactor while continuing to produce power for the user.

In one embodiment of the Multifunctional Power Conditioner 110, all subassembly power processing is done with high-frequency switching technology. High-frequency switching allows for smaller magnetic components, lower cost, and smaller size of the Multifunctional Power Conditioner 110. In addition, the stress in capacitive components is greatly reduced. Using the latest generation of magnetic materials and switching components, the stress reduction is achieved without any reduction in efficiency. The overall higher efficiency translates into a better utilization of the renewable energy source.

Specifically, one embodiment of the present invention will automatically accept and route electricity for current loads (converting to AC first via the Multifunctional Power Conditioner), with excess electricity routed to storage or to the grid, if available.

The Smart Controller 120 is responsible for this initial power routing. Excess DC energy is routed to the loads first, then to storage, and finally to the grid, if connected. The storage process will first recharge the battery and then route energy to the electrolyzer 140 for hydrogen generation and storage.

The Smart Controller 120 monitors battery voltage, current, and state of charge. When the batteries are full and the hydrogen storage tanks 170 are not full, DC electricity is routed to the electrolyzer 140. The Smart Controller 120 detects the level of hydrogen in the storage tanks 170, which can be separate from the unit. The electrolyzer 140 will run using excess energy until the tanks are full.

If there is a grid connection, electricity above and beyond all of these processes is routed back into the grid, generating a credit from the local utility for the customer. If no grid connection is available, excess electricity above and beyond all of these processes can be stored in additional tanks.

To satisfy demand, the Smart Controller 120, via the Multifunctional Power Conditioner 110, routes AC power to “Power Out” while converting from DC in the process. This power can come either from the current sources of renewable energy (DC supply), or, if unavailable, from electricity stored in the battery banks 160 or ultracapacitors, or from the fuel cell stack 130, which consumes the stored hydrogen to generate electricity.

The Smart Controller 120 is responsible for this electricity routing by detecting the demand and taking the electrical energy supplied from one of the four available sources: 1) renewable energy source (primary), 2) batteries, 3) fuel cell stack, and 4) the utility grid, if needed (preferably at off-peak hours). The present system also includes a “Hydrogen Out” port 172 in the hydrogen storage subsystems 170, which could satisfy other energy needs, such as heating, cooking, vehicle refueling, and the like.

The present invention can be implemented in a wide range of sizes and configurations, depending on the climate and energy needs of the unit's destination. It can also be adapted to suit any climate or energy load situation.

The present invention has the ability to utilize geothermal heating and cooling technology to provide a climate-controlled cabinet unit for operating temperature-sensitive applications, increasing operating efficiency by decreasing subsystems loads.

These and other advantages of the present invention will be apparent to those skilled in the art from the foregoing specification. Accordingly, it will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention. Reference herein to details of the illustrated embodiments is not intended to limit the scope of the claims, which themselves recite those features regarded as essential to the invention.

What is claimed is:

1. A renewable energy management and storage system, comprising:
a multifunctional power conditioner;
an energy storage subsystem; and
a smart controller,
wherein the multifunctional power conditioner is in electrical communication with a direct current electrical power circuit, and an alternating current electrical power circuit;
wherein the direct current electrical power circuit is in electrical communication with at least one renewable energy source;
wherein the multifunctional power conditioner is in electrical communication with the energy storage subsystem and the smart controller, the energy storage subsystem is also in electrical communication with the smart controller; and
whereby the smart controller intelligently routes the electrical power between the direct current circuit and the alternating current circuit via the multifunctional power conditioner, and at the same time determines the optimal routing for electrical storage based on usage and demand.

2. The system of claim 1, wherein electrical power from the direct current circuit is converted to alternating current electric power via the multifunctional power conditioner, and supplied to the alternating current circuit.

3. The system of claim 1, wherein the energy storage subsystem comprises one or more electrochemical cells.

4. The system of claim 1, wherein the energy storage subsystem comprises one or more ultracapacitors.

5. The system of claim 1, wherein the energy storage subsystem comprises:
at least one electrolyzer;
at least one fuel cell; and
at least one hydrogen storage tank,
wherein the at least one electrolyzer and the at least one fuel cell are in electrical communication with the multifunctional power conditioner and the smart controller, and the at least one electrolyzer and the at least one fuel cell are in gas communication with the at least one hydrogen storage tank.

6. The system of claim 5, wherein electrical power from the direct current circuit is conditioned via the multifunctional power conditioner, and supplied to the electrolyzer.

7. The system of claim 5, wherein direct current electrical power from the fuel cell is converted to alternating current electric power via the multifunctional power conditioner, and supplied to the alternating current circuit.

8. The system of claim 5, wherein the hydrogen storage tank comprises a port for gaseous hydrogen output.

9. The system of claim 1, wherein the multifunctional power conditioner is also in electrical communication with a public utility grid.

10. The system of claim 9, wherein electrical power from the public utility grid is stored in the energy storage subsystem.

11. The system of claim 9, wherein energy stored in the energy storage subsystem is extracted and converted to alternating current electric energy to supply the alternating current circuit.

12. The system of claim 9, wherein electrical power from the direct current circuit is converted to alternating current electric power via the multifunctional power conditioner, and transmitted to the public utility grid.

13. The system of claim 1, wherein the multifunctional power conditioner and the smart controller are housed in a unitary enclosure.

14. The system of claim 5, wherein the multifunctional power conditioner, electrolyzer, fuel cell, and the smart controller are housed in a unitary enclosure.

15. A Smart Controller for a renewable energy management and storage system, comprising:
a sensor input module, wherein at least one sensor input from at least one component of the renewable energy management and storage system is received;
a processor, wherein the sensor input is processed; and
a controller, wherein at least one control signal is sent to at least one component of the renewable energy management and storage system.

16. The Smart Controller of claim 15, wherein the at least one component of the renewable energy management and storage system is one or more of a multifunctional power conditioner, a fuel cell, an electrolyzer, an electrochemical cell, and a hydrogen storage tank.

17. A multifunctional power conditioner for a renewable energy management and storage system, comprising:
a direct current input converter;
a direct current buck/boost;
a direct current to alternating current inverter; and
a direct current bus,
wherein each of the direct current input converter, the direct current buck/boost, and the direct current to alternating current inverter are in electrical communication with the direct current bus.

18. The multifunctional power conditioner of claim 17, further comprising a digital signal processor.

19. The multifunctional power conditioner of claim 17, wherein the direct current input converter, the direct current buck/boost, and the direct current to alternating current inverter are integrated into a controller using high frequency switching technology.
